(19) United States
(12) Patent Application Publication
(10) Pub. No.: US 2022/0174390 A1
(43) Pub. Date: Jun. 2, 2022

(54) WIRELESS HEADSET CHARGING SYSTEM

(71) Applicant: AFH Industries Inc., New York, NY (US)

(72) Inventor: Jianguo Sun, Liuyang City (CN)

(21) Appl. No.: 17/456,792

(22) Filed: Nov. 29, 2021

(30) Foreign Application Priority Data
Dec. 1, 2020 (CN) 202030735612.1

(51) Int. Cl. H04R 1/10; H02J 50/00; H02J 7/00

(52) U.S. Cl. CPC H04R 1/1025; H02J 7/0044; H02J 50/005

(57) ABSTRACT

A wireless earphone charging system may include at least one wireless earpiece and a charging device, where the charging device includes at least one slot configured to receive the at least one wireless earpiece and provide an electrical connection thereto and a wireless charging element configured to provide wireless charging.

### CROSS-REFERENCE TO RELATED APPLICATIONS

The present application claims benefit of and priority to Chinese Design Patent Application No. 202030735612.1 filed Dec. 1, 2020, the entire content of which is incorporated by reference herein.

### FIELD OF THE INVENTION

The present invention generally relates to a wireless headset charging system including at least one wireless earpiece and a charging device configured to receive the wireless earpiece where the charging device includes at least one slot with an electrical contact configured for electrical connection to the wireless earpiece and a wireless charging element.

BACKGROUND

Wireless earphones have become an increasingly common accessory. Conventional wireless earphones typically communicate with a smart phone or other personal electronic device using a wireless communication protocol, such as BLUETOOTH, for example. Audio information is communicated to the earphones via the wireless communication protocol and the earphones produce sound based on the audio information. Since the earphones are wireless, they typically include a power source that requires recharging. Conventional wireless earphones are typically sold with a charging case that is configure to physically receive the earphones and includes one or more electrical contacts that electrically connect to the earphones when they are in place to provide for charging of the rechargeable power sources therein. Mobile electronic devices such as smart phones, tables and laptop computers, to name a few, with which the earphones are commonly used, also typically include rechargeable power sources that have to be charged periodically as well. The conventional charging devices used to recharge wireless earphones, however, are not configured to charge mobile electronic devices such that a second charging device must be used. This requirement for additional charging devices results in additional costs as well as additional risks of failure of one or more of the charging devices.

It would therefore be beneficial to provide a charging system configured to receive and recharge wireless earphones and also configured to provide wireless charging of one or more mobile electronic devices.

### SUMMARY

In view of the above, it is the object of the present disclosure to provide a technological solution to address the long felt need and technological challenges faced in conventional earphone charging systems to provide a charging system that both receives and recharges at least one earpiece and also provides for wireless charging of a mobile electronic device positioned adjacent to the charging device.

In embodiments, a charging system in accordance with the present disclosure includes: (a) a first wireless earpiece; (b) a second wireless earpiece; and (c) a charging device, the charging device including: i. a first slot configured to receive the first wireless earpiece and provide an electrical connection thereto; ii. a second slot configured to receive the second wireless earpiece and provide an electrical connection thereto; and iii. a wireless charging element configured for providing wireless charging.

In embodiments, the first wireless earpiece includes a first contact configured for electrical connection to the charging device and to provide power to the first wireless earpiece; and the second wireless earpiece includes a second contact configured for electrical connection to the charging device and to provide power to the second wireless earpiece.

In embodiments, the first slot includes a first charging device contact configured for electrical connection to the first contact of the first wireless earpiece when the first wireless earpiece is positioned in the first slot; and the second slot includes a second charging device contact configured for electrical connection to the second contact of the second wireless earpiece when the second wireless earpiece is positioned in the second slot.

In embodiments, the charging device includes at least one charging device power supply electrically connected to the first charging device contact and the second charging device contact to provide power to the first charging device contact and the second charging device contact.

In embodiments, the wireless charging element is electrically connected to the charging device power supply.

In embodiments, the wireless charging element is an inductive charging element that is activated by power supplied by the charging device power supply to produce an electromagnetic field suitable to induce current in an external device positioned adjacent to the charging device.

In embodiments, the wireless charging element is an inductive charging element configured to allow for induction of a current therein that is provided to the charging element power supply when the wireless charging element is exposed to a varying electromagnetic field provided by an external device adjacent to the charging device.

In embodiments, each of the first wireless earpiece and the second wireless earpiece includes a respective rechargeable power supply electrically connected to the first contact and the second contact, respectively.

In embodiments, each of the first wireless earpiece and the second wireless earpiece includes a respective charging circuit positioned between the respective rechargeable power supply and the first contact and the second contact, respectively.

In embodiments, the system includes a fastening element configured to secure the charging device to an external device.

In embodiments, a charging system in accordance with an embodiment of the present disclosure includes at least one wireless earpiece; and a charging device, the charging device including at least one slot configured to receive the at least one wireless earpiece and provide an electrical connection thereto; and a wireless charging element configured to provide wireless charging.

In embodiments, the at least one wireless earpiece includes at least one contact configured for electrical connection to the charging device and to provide power from the charging device to the at least one wireless earpiece.

In embodiments, the at least one slot includes a charging device contact configured for electrical connection to the at least one contact of the at least one wireless earpiece when the at least one wireless earpiece is positioned in the at least one slot.

In embodiments, the charging device further comprises at least one charging device power supply electrically connected to the at least one charging device contact to provide power to the at least one charging device contact.

In embodiments, the wireless charging element is electrically connected to the charging device power supply.

In embodiments, the wireless charging element is an inductive charging element that is activated by power supplied by the charging device power supply to produce an electromagnetic field suitable to induce current in an external device positioned adjacent to the charging device.

In embodiments, the wireless charging element is an inductive charging element configured to allow for induction of a current that is provided to the charging element power supply when exposed to a varying electromagnetic field provided by an external device.

In embodiments, the at least one wireless earpiece includes a rechargeable power supply electrically connected to the at least one contact.

In embodiments, the system includes a charging circuit positioned between the rechargeable power supply and the at least one contact to provide power to the rechargeable power supply.

In embodiments, the system includes a fastening element configured to secure the charging device to an external device.

### BRIEF DESCRIPTION OF THE DRAWINGS

The above and related objects, features and advantages of the present disclosure will be more fully understood by reference to the following detailed description of the preferred, albeit illustrative, embodiments of the present invention when taken in conjunction with the accompanying figures, wherein:

FIG. 1 is a schematic illustration of an earphone charging system in accordance with an embodiment of the present disclosure;

FIG. 2 illustrates the earphone charging system of FIG. 1 with the wireless earpiece(s) removed from the charging device in accordance with an embodiment of the present disclosure;

FIG. 3 illustrates a detailed view of a wireless earpiece of the earphone charging system of FIG. 1 in accordance with an embodiment of the present disclosure;

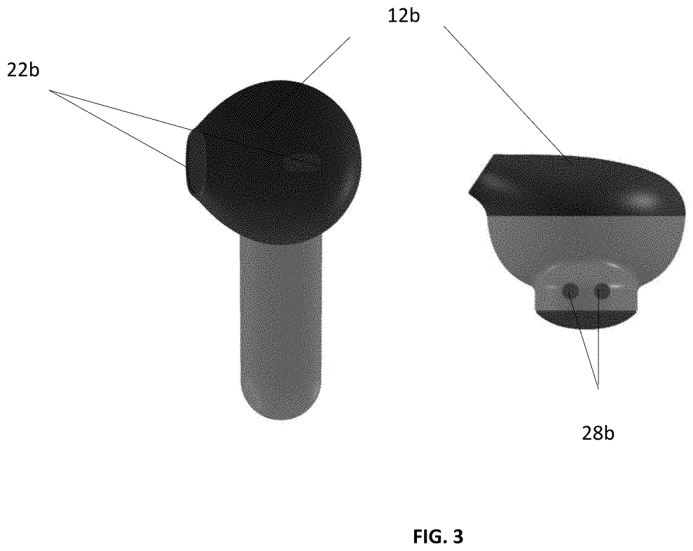

FIG. 4 illustrates an exemplary block diagram of the exemplary wireless earpiece of FIG. 3 in accordance with an embodiment of the present disclosure;

FIG. 5 illustrates an earphone charging system coupled to a mobile electronic device to charge the device in accordance with an embodiment of the present disclosure;

FIG. 6 illustrates an earphone charging system positioned on a wireless charging pad such that the wireless charging pad induces a current in the charging device in accordance with an embodiment of the present disclosure;

FIG. 7 illustrates the opposite side of the charging device of the system of FIG. 1 in accordance with an embodiment of the present disclosure;

FIG. 8 illustrates the opposite side of the charging device in FIG. 6 showing a fastening element positioned thereon in accordance with an embodiment of the present disclosure; and

FIG. 9 is an exemplary block diagram of the charging device of FIG. 1, 2, 5, 6, 7 or 8 in accordance with an embodiment of the present disclosure.

### DETAILED DESCRIPTION OF THE EXEMPLARY EMBODIMENTS

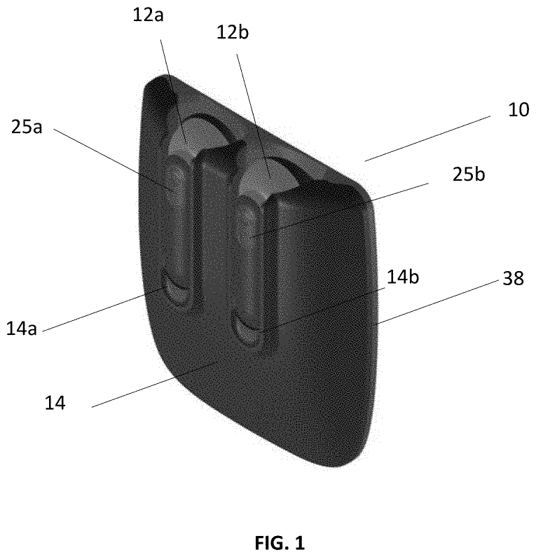

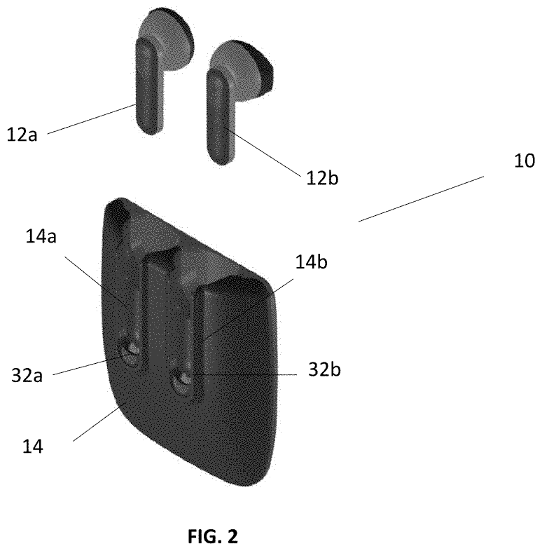

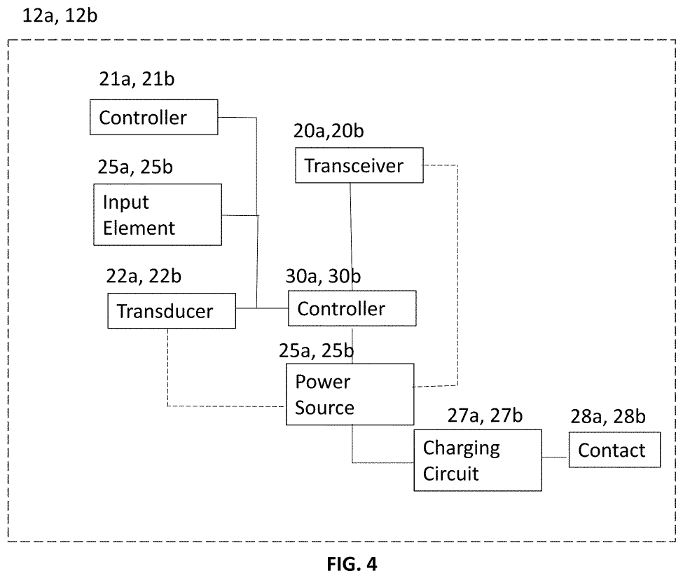

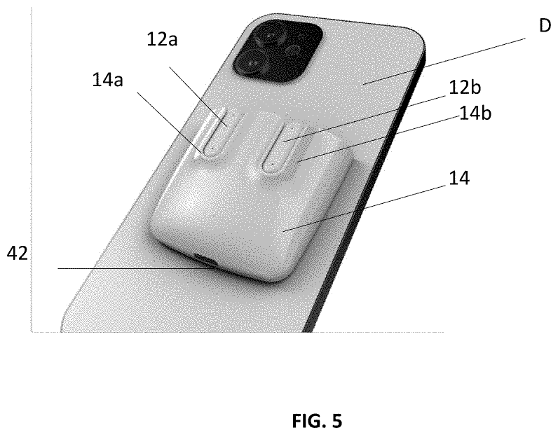

The present invention generally relates to a charging system 10 (see FIGS. 1-2, for example) for charging a wireless earpiece 12a, 12b that includes a wireless charging element 38 suitable for use in charging an external mobile electronic device D such as a smart phone, tablet or laptop computer, to name a few (see FIG. 5, for example). In embodiments, the system 10 may include at least one wireless earpiece 12a, 12b, a charging device 14 configured to receive the at least one wireless earpiece, the charging device including at least one electrical contact 32a, 32b (see FIG. 4, for example) electrically connected to the at least one wireless earpiece 12a, 12b when it is received in the charging device and a wireless charging element 38 configured to provide wireless charging associated with an external device D (see FIG. 5, for example). While the external device D is illustrated as a smart phone, it may be any mobile electronic device including a tablet or a laptop computer, to name a few.

FIG. 1 is a schematic illustration of the wireless earphone charging system 10 in accordance an embodiment of the present disclosure. FIGS. 1-2 show a first wireless earpiece 12a and a second wireless earpiece 12b, which are structured and function in substantially the same manner except that they are configured for insertion into a left and right ear, respectively, of a user. The system 10 may include additional wireless earpieces or a single wireless earpiece. In embodiments, each wireless earpiece 12a, 12b may include one or more transceivers 20a, 20b (see FIG. 4, for example) that send and receive information wirelessly to and from the first wireless earpiece 12a and the second wireless earpiece 12b. In embodiments, the transceivers 20a, 20b may be provided in the first wireless earpiece 12a and the second wireless earpiece 12b, respectively. In embodiments, each of the transceivers 20a, 20b may use a wireless communication protocol such as BLUETOOTH, WiFi or the like. In embodiments, each wireless earpiece 12a, 12b may include one or more transducers 22a, 22b, respectively, to produce sound based on at least audio information received by the transceivers 20a, 20b. In embodiments, the audio information may be received from the mobile electronic device D, or any other wirelessly connected device. In embodiments, the sound may be music, speech, etc. In embodiments, each wireless earpiece 12a, 12b may include a power source 24a, 24b, respectively, such as a rechargeable battery or capacitor, to name a few, that powers at least the transceivers 20a, 20b and the transducers 22a, 22b. In embodiments, each wireless earpiece 12a, 12b may include an electrical contact 28a, 28b, respectively, that may be electrically connected to the respective power source 25a, 25b to provide electricity to the power source 25a, 25b for recharging. In embodiments, each wireless earpiece 12a, 12b may include a charging circuit 27a, 27b, electrically connected between the respective electrical contacts 28a, 28b and the respective power sources 25a, 25b to control recharging of the power source 25a, 25b. In embodiments, each wireless earpiece 12a, 12b, respectively, may include a controller 30a, 30b, that may control the operation of the transceivers 20a, 20b, the transducers 22a, 22b and charging circuit 27a, 27b. The controller 30a, 30b may be a microprocessor or other processing device or circuit. In embodiments, power may be provided to the transceivers 20a, 20b, respectively, and the transducers 22a, 22b, respectively, via the controllers 30a, 30b, respectively. In embodiments, power may be provided directly from the power source 25a, 25b to the transceivers 20a, 20b and the transducers 22a, 22b and the controllers 30a, 30b may provide instructions to control operation of the transceivers 20a, 20b and the transducers 22a, 22b and may provide the audio information to the transducers 22a, 22b. The audio information may be provided from the transceivers 20a, 20b to the controllers 30a, 30b. In embodiments, one or more memory elements may be included in or operatively connected to the controllers 30a, 30b and may store the audio information, at least temporarily, before it is provided to the transducers 22a, 22b. The one or more memory elements may also include instructions associate with the operation of the transceivers 20a, 20b and the transducers 22a, 22b.

In embodiments, one or more input elements 25a, 25b may be provided in or on the earpieces 12a, 12b. In embodiments, the input elements 25a, 25b may be connected to the controllers 30a, 30b and may be used to activate the transceivers 20a, 20b and the transducers 22a, 22b to receive audio information and provide sound. In embodiments, the input elements may be buttons, switches, sliders, dials, etc. Activating and deactivating the transceivers 20a, 20b and transducers 22a, 22b as desired by the user allows for conservation of power. In embodiments, one or more indicators 21a, 21b may be provided and activated on the respective earpieces 12a, 12b to indicate that they are active. In embodiments, the indicators 21a, 21b may be activated to indicate the earpieces 12a, 12b are being charged. In embodiments, the indicators 21a, 21b may be activated to indicate the earpieces 12a, 12b are in need of being charged.

In embodiments, the charging device 14 may include at least one receiving slot 14a, 14b configured to receive and securely hold the at least one wireless earpiece 12a, 12b. In embodiments, where the first wireless earpiece 12a and second wireless earpiece 12b are used, the charging device 14 may include a first receiving slot 14a configured to receive the first wireless earpiece 12a and to secure it in the charging device 14 and a second receiving slot 14b configured to receive the second wireless earpiece 12b and secure it in the charging device 14. In embodiments, each receiving slot may include a charging device contact, for example, the first receiving slot 14a may include a first charging device contact 32a positioned for contact with the first contact 28a provided on the first wireless earpiece 12a when the first wireless earpiece 12a is received and secured in the first receiving slot 14a. In embodiments, the second receiving slot 14b may include a second charging device contact 32b positioned for contact with the second contact 28b provided on the second wireless earpiece 12b when the second wireless earpiece 12b is received and secured in the second slot 14b.

In embodiments, the first charging device contact 32a and the second charging device contact 32b may be electrically connected to a charging device power supply 36 provided in the charging device 14. In embodiments, the charging device power supply 36 may provide electricity to the first charging device contact 32a and the second charging device contact 32b, which, as noted above, may be electrically connected to the first contact 28a and the second contact 28b, respectively, to recharge the first wireless earpiece 12a and the second wireless earpiece 12b, respectively.

In embodiments, the charging device 14 may include a wireless charging element 38 electrically connected to the charging device power supply 36. In embodiments, the wireless charging element 38 may be an inductive charging element. In embodiments, the wireless charging element 38 may be activated to induce a current in an external mobile electronic device

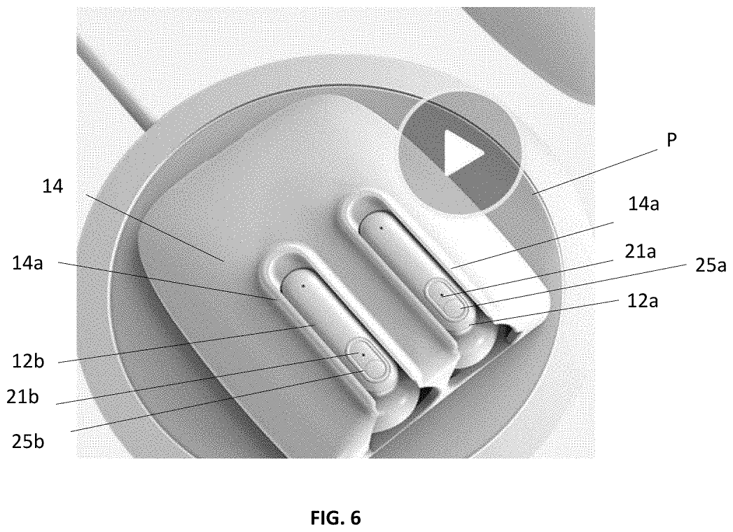

D, or other external device, positioned adjacent to the charging device 14 to charge the mobile electronic device D, as illustrated in FIG. 5, for example. In embodiments, the wireless charging element 38 may also be configured such that a current may be induced in the wireless charging element 38 by an external device such as the charging pad P illustrated in FIG. 6, for example. As noted above, the wireless charging element 38 is electrically connected to the charging device power supply 36 such that the current induced in the wireless charging element 38 may be used to recharge the charging device power supply 36. In embodiments, the wireless charging pad P may be positioned adjacent to the charging device 14 and may induce the current in the wireless charging element, as illustrated in FIG. 6, for example.

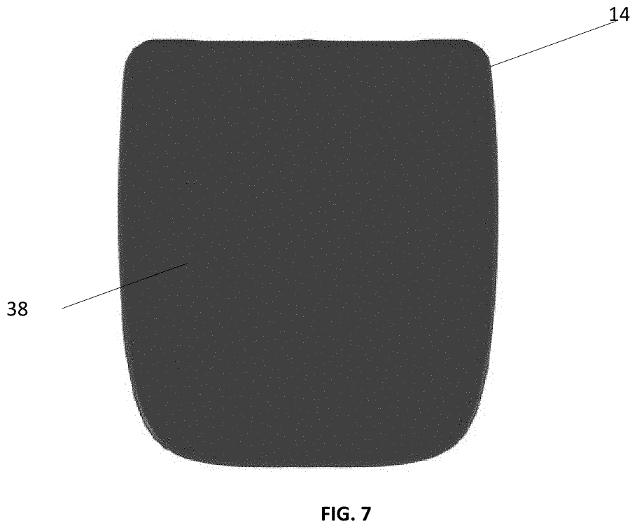

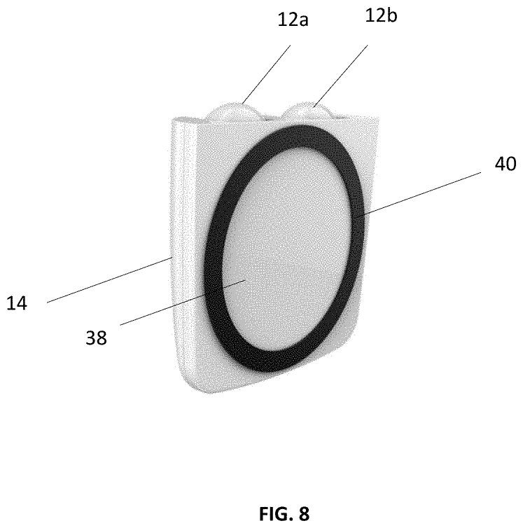

In embodiments, the wireless charging element 38 may be positioned on a side of the charging device 14 opposite the receiving slots 14a, 14b as indicated in FIG. 7, for example. In embodiments, a fastening element 40 (see FIG. 8 for example) may be provided on the side of the charging device 14 opposite the receiving slots 14a, 14b. In embodiments, the fastening element 40 may be a magnet that may be used to secure the charging device 14 to the mobile electronic device D, for example. In embodiments, the fastening element 40 may be a hook and loop type fastener. In embodiments, the fastening element 40 may be or may include one or more depressions or protrusions in or from the surface of the charging device 14 that correspond to a shape of at least a portion of the mobile electronic device D such that the mobile electronic device D or a portion thereof may be coupled to the charging device 14. In embodiments, the fastening element 40 may be used to provide a physical connection between the charging device 14 and the mobile electronic device D to avoid separation which may disrupt wireless charging of the device D.

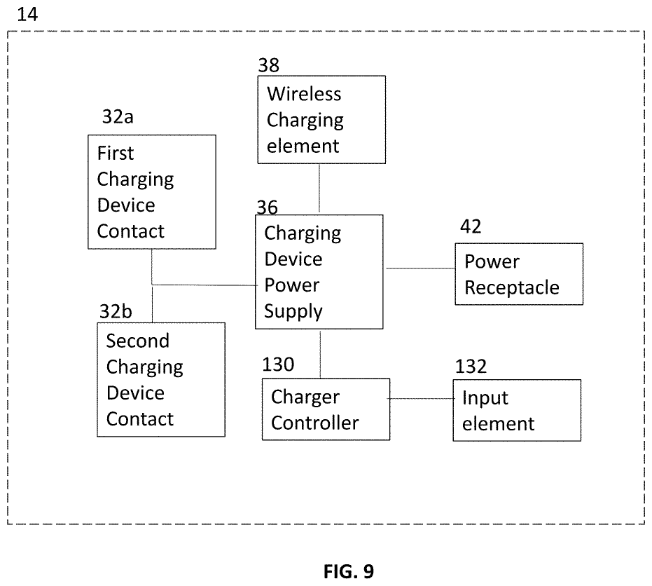

In embodiments, the charging device 14 may include a power receptacle 42 which may be configured to receive external power via a wire from a plug or other external power supply. In embodiments, the power receptacle may be a USB connector. In embodiments, the power receptacle may be any other suitable connector. In embodiments, the power receptacle 42 may be electrically connected to the charging device power supply 36 to provide power thereto, either for recharging or for use in recharging the wireless earpiece(s) 12a, 12b via the charging device contacts 32a, 32b and/or activating the wireless charging element 38. In embodiments, the charging device 14 may include a charger controller 130 (see FIG. 9, for example) that may be connected to and control the power supply 36 and/or any of the other elements of the charging device 14. In embodiments, the controller 130 may control whether the charger power supply 36 provides power to the contacts 32a, 32b and/or the wireless charging element 38. In embodiments, the charger controller 130 may control the charger power supply 36 to provide power to the wireless charging element 38 when the power receptacle 42 is connected to an external power supply such that the charging device 14 may be used to provide wireless charging to an external electronic device, for example, device D. In embodiments, the charger controller 130 may control the power supply 36 to receive power from the wireless charging element 38, to recharge the power supply 36. In embodiments, one or more input device 132 may be connected to the controller 130 such that the controller 130 controls at least the power supply 36 based on input provided from the input device 132. In embodiments, the input device 132 may be a button, switch, dial etc. that may be used to provide input to the charger controller 130 to control the charging device 14 to provide power to the contacts 32a, 32b and/or the wireless charging element 38 or to be recharged based on power provided from an adjacent device via the wireless charging element. In embodiments, a charger indicator (not shown) may be included to indicate whether the charging device 14 is in a charging mode providing power to the wireless charging element 38 or in recharging mode being recharged via the wireless charging element 38.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

1. A charging system comprising:
(a) a first wireless earpiece;
(b) a second wireless earpiece; and
(c) a charging device, the charging device comprising:
i. a first slot configured to receive the first wireless earpiece and provide an electrical connection thereto;
ii. a second slot configured to receive the second wireless earpiece and provide an electrical connection thereto; and
iii. a wireless charging element configured for providing wireless charging.

2. The charging system of claim 1, wherein:
(1) the first wireless earpiece includes a first contact configured for electrical connection to the charging device and to provide power to the first wireless earpiece; and
(2) the second wireless earpiece includes a second contact configured for electrical connection to the charging device and to provide power to the second wireless earpiece.

3. The charging system of claim 2, wherein:
(3) the first slot includes a first charging device contact configured for electrical connection to the first contact of the first wireless earpiece when the first wireless earpiece is positioned in the first slot; and
(4) the second slot includes a second charging device contact configured for electrical connection to the second contact of the second wireless earpiece when the second wireless earpiece is positioned in the second slot.

4. The charging system of claim 3, wherein the charging device further comprises:
(d) at least one charging device power supply electrically connected to the first charging device contact and the second charging device contact to provide power to the first charging device contact and the second charging device contact.

5. The charging system of claim 4, wherein the wireless charging element is electrically connected to the charging device power supply.

6. The charging system of claim 5, wherein the wireless charging element is an inductive charging element that is activated by power supplied by the charging device power supply to produce an electromagnetic field suitable to induce current in an external device positioned adjacent to the charging device.

7. The charging system of claim 5, wherein the wireless charging element is an inductive charging element configured to allow for induction of a current therein that is provided to the charging element power supply when the wireless charging element is exposed to a varying electromagnetic field provided by an external device adjacent to the charging device.

8. The charging system of claim 2, wherein each of the first wireless earpiece and the second wireless earpiece includes a respective rechargeable power supply electrically connected to the first contact and the second contact, respectively.

9. The charging system of claim 8, wherein each of the first wireless earpiece and the second wireless earpiece includes a respective charging circuit positioned between the respective rechargeable power supply and the first contact and the second contact, respectively.

10. The charging system of claim 1, further comprising a fastening element configured to secure the charging device to an external device.

11. A charging system comprising:
(a) at least one wireless earpiece; and
(b) a charging device, the charging device including:
i. at least one slot configured to receive the at least one wireless earpiece and provide an electrical connection thereto; and
ii. a wireless charging element configured to provide wireless charging.

12. The charging system of claim 11, wherein the at least one wireless earpiece includes at least one contact configured for electrical connection to the charging device and to provide power from the charging device to the at least one wireless earpiece.

13. The charging system of claim 12, wherein the at least one slot includes a charging device contact configured for electrical connection to the at least one contact of the at least one wireless earpiece when the at least one wireless earpiece is positioned in the at least one slot.

14. The charging system of claim 13, wherein the charging device further comprises at least one charging device power supply electrically connected to the at least one charging device contact to provide power to the at least one charging device contact.

15. The charging system of claim 13, wherein the wireless charging element is electrically connected to the charging device power supply.

16. The charging system of claim 15, wherein the wireless charging element is an inductive charging element that is activated by power supplied by the charging device power supply to produce an electromagnetic field suitable to induce current in an external device positioned adjacent to the charging device.

17. The charging system of claim 15, wherein the wireless charging element is an inductive charging element configured to allow for induction of a current that is provided to the charging element power supply when exposed to a varying electromagnetic field provided by an external device.

18. The charging system of claim 12, wherein the at least one wireless earpiece includes a rechargeable power supply electrically connected to the at least one contact.

19. The charging system of claim 18, further comprising a charging circuit positioned between the rechargeable power supply and the at least one contact to provide power to the rechargeable power supply.

20. The charging system of claim 11, further comprising a fastening element configured to secure the charging device to an external device.
